(19) United States
(12) Patent Application Publication
(10) Pub. No.: US 2023/0406515 A1
(43) Pub. Date: Dec. 21, 2023

(54) HYDROGEN-COOLED ENVIRONMENTAL CONTROL SYSTEM

(71) Applicant: Hamilton Sundstrand Corporation, Charlotte, NC (US)

(72) Inventors: Leo J. Veilleux, JR., Wethersfield, CT (US); Lubomir A. Ribarov, West Hartford, CT (US)

(21) Appl. No.: 17/746,535

(22) Filed: May 17, 2022

(51) Int. Cl. B64D 13/08; B64D 41/00

(52) U.S. Cl. CPC B64D 13/08; B64D 2013/0618; B64D 41/00

(57) ABSTRACT

A hydrogen-cooled environmental control system (ECS) is provided and includes a pressurizing system including an electric compressor that compresses RAM air into pressurized warm RAM air for a cabin and a heat exchanger in which the pressurized warm RAM air is selectively cooled by hydrogen flown from a hydrogen fuel tank toward a combustor in accordance with conditions of the pressurized warm RAM air prior to the pressurized warm RAM air reaching the cabin.

### BACKGROUND

The following description relates to environmental control systems (ECSs) and, more specifically, to an integrated hydrogen-cooled ECS.

Consistent with modern advanced more electric aircraft/more electric engine (MEA/MEE) architectures, an integrated ECS can use electrically driven cabin air compressors to compress incoming ram air that enters the aircraft fuselage through opening scoops. This avoids wasteful bleeding of hot pressurized engine compressed air while improving overall thermodynamic performance. The pressurized warmed ram air is monitored with pressure sensors and temperature sensors. It flows through an ozone (O3) converter before it is flown to heat exchangers for cooling. A modulating deflector flap can be used to modulate the amount of ram air incoming to the inlet of each air compressor.

The use of dedicated heat exchangers for ECS can add weight while limiting available space for other needed equipment.

What is needed is a way to further integrate an ECS into modern MEA/MEE architecture. This is especially true for those cases where power is provided by on-board hydrogen.

### BRIEF DESCRIPTION

According to an aspect of the disclosure, a hydrogen-cooled environmental control system (ECS) is provided and includes a pressurizing system including an electric compressor that compresses RAM air into pressurized warm RAM air for a cabin and a heat exchanger in which the pressurized warm RAM air is selectively cooled by hydrogen flown from a hydrogen fuel tank toward a combustor in accordance with conditions of the pressurized warm RAM air prior to the pressurized warm RAM air reaching the cabin.

In accordance with additional or alternative embodiments, the cabin is an aircraft cabin of an aircraft, the pressurizing system is provided as first and second pressurizing systems for each side of the aircraft and the heat exchanger is provided as first and second heat exchangers for each side of the aircraft.

In accordance with additional or alternative embodiments, the pressurizing system further includes a RAM air inlet including a controllable deflector flap, pressure and temperature sensors upstream and downstream from the electric compressor and an ozone converter interposed between the electric compressor and the heat exchanger.

In accordance with additional or alternative embodiments, the pressurizing system further includes an electric heat load heat exchanger interposed between the heat exchanger and the cabin and pressurized cooled RAM air from the heat exchanger is selectively used for cooling an electric heat load in the electric heat load heat exchanger in accordance with conditions of the pressurized cooled RAM air and the electric heat load.

In accordance with additional or alternative embodiments, the hydrogen-cooled ECS further includes a bypass line by which hydrogen flown from the hydrogen fuel tank toward the combustor bypasses the heat exchanger and a valve which is controllable to adjust an amount of the hydrogen that is permitted to flow along the bypass line.

In accordance with additional or alternative embodiments, the hydrogen-cooled ECS further includes a fuel control valve upstream from the combustor to control an amount of the hydrogen that is permitted to flow into the combustor.

In accordance with additional or alternative embodiments, the hydrogen-cooled ECS further includes a fuel cell in parallel with the combustor and a valve which is controllable to direct a first portion of the hydrogen toward the combustor and a second portion of the hydrogen toward the fuel cell.

In accordance with additional or alternative embodiments, the hydrogen-cooled ECS further includes an internal hydrogen leak sensor disposed within the heat exchanger to detect an internal hydrogen leak thereof, an external hydrogen leak sensor disposed at an exterior of the heat exchanger to detect an external hydrogen leak and a system to cut off a flow of the hydrogen into the heat exchanger in an event of the internal hydrogen leak and to cease the flow of the hydrogen in an event of the external hydrogen leak.

According to an aspect of the disclosure, a method of operating a hydrogen-cooled environmental control system (ECS) is provided and includes providing a pressurizing system including an electric compressor that compresses RAM air into pressurized warm RAM air for a cabin and selectively cooling the pressurized warm RAM air in a heat exchanger with hydrogen flown from a hydrogen fuel tank to a combustor in accordance with conditions of the pressurized warm RAM air prior to the pressurized warm RAM air reaching the cabin.

In accordance with additional or alternative embodiments, the cabin is an aircraft cabin of an aircraft, the pressurizing system is provided as first and second pressurizing systems for each side of the aircraft and the heat exchanger is provided as first and second heat exchangers for each side of the aircraft.

In accordance with additional or alternative embodiments, the method further includes selectively using pressurized cooled RAM air from the heat exchanger for cooling an electric heat load in accordance with conditions of the pressurized cooled RAM air and the electric heat load.

In accordance with additional or alternative embodiments, the method further includes at least one of controllably bypassing a flow of the hydrogen around the heat exchanger, controlling an amount of the hydrogen that is permitted to flow into the combustor, cutting off a flow of the hydrogen into the heat exchanger in an event of a leak within the heat exchanger and ceasing the flow of the hydrogen in an event of a leak at an exterior of the heat exchanger.

According to an aspect of the disclosure, hydrogen-cooled environmental control system (ECS) is provided and includes a bleed air system providing pressurized warm bleed air for a cabin, a pressurizing system in parallel with the bleed air system and comprising an electric compressor that compresses RAM air into pressurized warm RAM air for the cabin and a heat exchanger in which at least one of the pressurized warm bleed air and the pressurized warm RAM air is selectively cooled by hydrogen flown from at least one hydrogen fuel tank toward at least one combustor in accordance with respective conditions of the pressurized warm bleed air and the pressurized warm RAM air prior to the pressurized warm bleed air and the pressurized warm RAM air reaching the cabin.

In accordance with additional or alternative embodiments, the cabin is an aircraft cabin of an aircraft, the bleed air system is provided as first and second bleed air systems for each side of the aircraft, the pressurizing system is provided as first and second pressurizing systems for each side of the aircraft and the heat exchanger is provided as first and second heat exchangers for each side of the aircraft.

In accordance with additional or alternative embodiments, the pressurizing system further includes a RAM air inlet including a controllable deflector flap, pressure and temperature sensors upstream and downstream from the electric compressor and an ozone converter interposed between the electric compressor and the heat exchanger.

In accordance with additional or alternative embodiments, the pressurizing system further includes an electric heat load heat exchanger interposed between the heat exchanger and the cabin and pressurized cooled RAM air from the heat exchanger is selectively used for cooling an electric heat load in the electric heat load heat exchanger in accordance with conditions of the pressurized cooled RAM air and the electric heat load.

In accordance with additional or alternative embodiments, the hydrogen-cooled ECS further includes a bypass line by which hydrogen flown from the at least one hydrogen fuel tank toward the at least one combustor bypasses the heat exchanger and a valve which is controllable to adjust an amount of the hydrogen that is permitted to flow along the bypass line.

In accordance with additional or alternative embodiments, the hydrogen-cooled ECS further includes a fuel control valve upstream from the at least one combustor to control an amount of the hydrogen that is permitted to flow into the at least one combustor.

In accordance with additional or alternative embodiments, the hydrogen-cooled ECS further includes a fuel cell in parallel with the at least one combustor and a valve which is controllable to direct a first portion of the hydrogen toward the at least one combustor and a second portion of the hydrogen toward the fuel cell.

In accordance with additional or alternative embodiments, the hydrogen-cooled ECS further includes an internal hydrogen leak sensor disposed within the heat exchanger to detect an internal hydrogen leak thereof, an external hydrogen leak sensor disposed at an exterior of the heat exchanger to detect an external hydrogen leak and a system to cut off a flow of the hydrogen into the heat exchanger in an event of the internal hydrogen leak and to cease the flow of the hydrogen in an event of the external hydrogen leak.

These and other advantages and features will become more apparent from the following description taken in conjunction with the drawings.

### BRIEF DESCRIPTION OF THE DRAWINGS

The subject matter, which is regarded as the disclosure, is particularly pointed out and distinctly claimed in the claims at the conclusion of the specification. The foregoing and other features and advantages of the disclosure are apparent from the following detailed description taken in conjunction with the accompanying drawings in which:

FIG. 1 is a top-down view of an aircraft in which an ECS is deployed in accordance with embodiments;

FIG. 2 is a schematic illustration of an ECS of the aircraft of FIG. 1 in accordance with embodiments;

FIG. 3 is a schematic diagram of heat exchangers of the ECS of FIG. 2 in accordance with embodiments;

FIG. 4 is a flow diagram illustrating a method of operating an ECS in accordance with embodiments; and

FIG. 5 is a schematic illustration of an ECS of the aircraft of FIG. 1 in accordance with further embodiments.

These and other advantages and features will become more apparent from the following description taken in conjunction with the drawings.

### DETAILED DESCRIPTION

As will be described below, an ECS is integrated into modern MEA/MEE architecture, especially where power is provided by on-board hydrogen. On-board stored compressed liquefied hydrogen (H2) is used both as fuel (i.e., propellant) for a combustor as well as coolant media for pressurized warmed ram air to be used for the ECS and for cabin pressurization. In addition, the cold H2 can be used as a heat sink for various on-board heat loads. Such loads can be, but are not limited to, lubrication systems, hydraulic system, pneumatic system, various electric waste heat loads, etc.

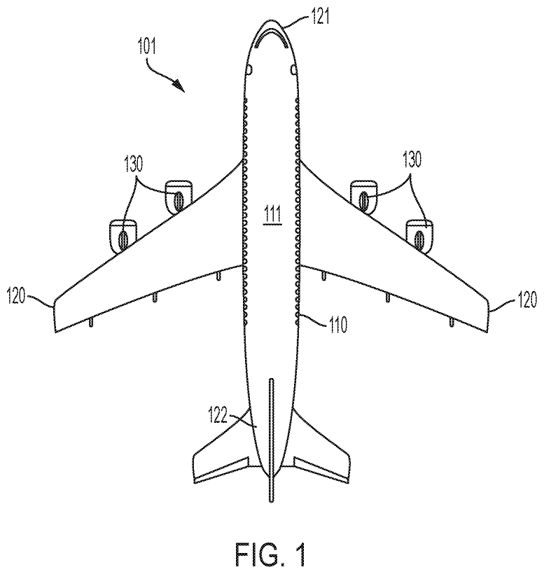

With reference to FIG. 1, an aircraft 101 is provided and includes a fuselage 110 which is formed to define a cabin 111 or an aircraft cabin in an interior thereof, aerodynamic features such as wings 120 that extend outwardly from the fuselage 110, a nose 121 at a forward end of the fuselage 110 and a tail section 122 at a rear end of the fuselage 110. The aircraft 101 further includes at least one engine 130 at either side of the aircraft 101 that generates power for flight and for other on-board powered features.

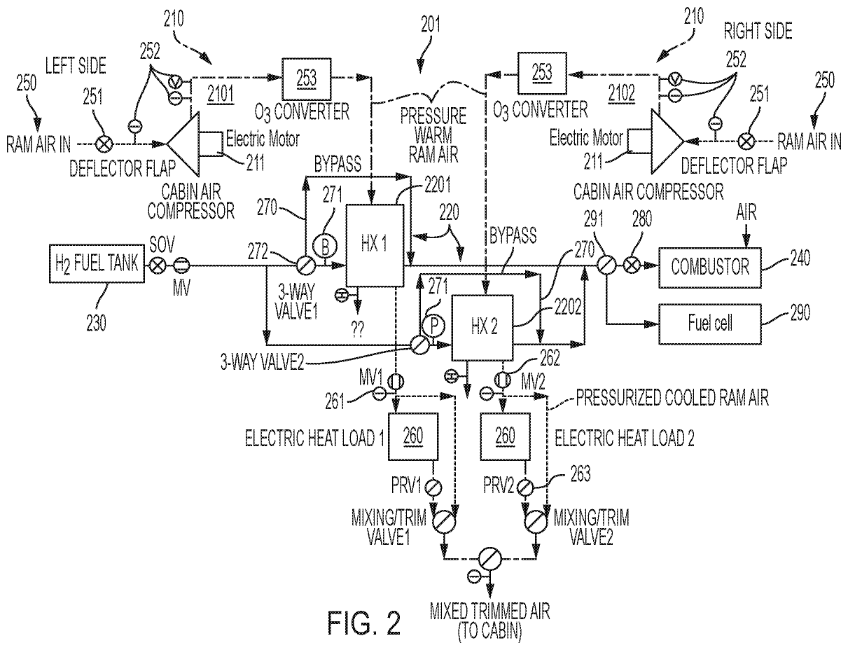

With reference to FIG. 2, a hydrogen-cooled ECS 201 is provided for use with each side of the aircraft 101 of FIG. 1. The hydrogen-cooled ECS 201 includes a pressurizing system 210 that can be provided as a first pressurizing system 2101 on a first side of the aircraft 101 and a second pressurizing system 2102 on a second side of the aircraft 101. Each of the first pressurizing system 2101 and the second pressurizing system 2102 includes an electric compressor 211 that compresses RAM air into pressurized warm RAM air for the cabin 111 of FIG. 1. The hydrogen-cooled ECS 201 further includes a heat exchanger 220 that can be provided as a first heat exchanger 2201 on the first side of the aircraft 101 and a second heat exchanger 2202 on the second side of the aircraft 101.

Prior to the pressurized warm RAM air reaching the cabin 111, the pressurized warm RAM air is selectively cooled in each of the first heat exchanger 2201 and the second heat exchanger 2202 by hydrogen (i.e., cold, liquid hydrogen) that is flown from a hydrogen fuel tank 230 toward a combustor 240, which is configured to generate power for the at least one engine 130 (see FIG. 1). The selective cooling of the pressurized warm air is executable in accordance with conditions of the pressurized warm RAM air, such as a pressure and a temperature of the pressurized warm air.

The following description will provide descriptions of additional features of the hydrogen-cooled ECS 201 of FIG. 2. Unless otherwise noted, these descriptions will refer to components of the hydrogen-cooled ECS 201 in the singular and it will be understood that they can each be provided on both sides of the aircraft 101. This is done for clarity and brevity and should not be interpreted as limiting the description or the claims in any way.

The pressurizing system 210 (i.e., each of the first pressurizing system 2101 and the second pressurizing system 2102) further includes a RAM air inlet 250 that includes a controllable deflector flap 251, which is controllable to adjust an amount of RAM air that is permitted to enter into the RAM air inlet 250, pressure and temperature sensors 252 operably disposed upstream and downstream from the electric compressor 211 to sense and thus determine the conditions of the pressurized warm RAM air and an ozone converter 253. The ozone converter 253 is operably interposed between the electric compressor 211 and the heat exchanger 220 (i.e., the first heat exchanger 2201 and the second heat exchanger 2202) to remove ozone from the pressurize warm RAM air.

The pressurizing system 210 (i.e., each of the first pressurizing system 2101 and the second pressurizing system 2102) further includes an electric heat load heat exchanger 260, additional sensors 261, a metering valve 262 and a pressure relief valve 263. The electric heat load heat exchanger 260 is operably interposed between the heat exchanger 220 (i.e., the first heat exchanger 2201 and the second heat exchanger 2202) and the cabin 111 (see FIG. 1). The additional sensors 261 can include temperature sensors to sense a temperature of pressurized cooled RAM air leaving the heat exchanger 220. The metering valve 262 can be controlled in accordance with the readings of the additional sensors 261 to adjust an amount of the pressurized cooled RAM air that is permitted to leave the heat exchanger 220. Within the electric heat load heat exchanger 260, pressurized cooled RAM air from the heat exchanger 220 is selectively used for cooling an electric heat load in accordance with conditions of the pressurized cooled RAM air, as sensed by the additional sensors 261, and the electric heat load. The pressure relief valve 263 is operably disposed to prevent a pressure within the electric heat load heat exchanger 260 from exceeding a predefined limit.

The pressurizing system 210 (i.e., each of the first pressurizing system 2101 and the second pressurizing system 2102) further includes a bypass line 270 by which hydrogen flown from the hydrogen fuel tank 230 toward the combustor 240 bypasses the heat exchanger 220 (i.e., the first heat exchanger 2201 and the second heat exchanger 2202), additional sensors 271 to sense a temperature and/or a pressure of the hydrogen, and a valve 272, such as a three-way valve. The valve 272 is controllable in accordance with readings of the additional sensor 271 to adjust an amount of the hydrogen that is permitted to flow along the bypass line 270.

The hydrogen-cooled ECS 201 can further include a fuel control valve 280. The fuel control valve 280 is operably disposed upstream from the combustor 240 to control an amount of the hydrogen that is permitted to flow into the combustor 240.

The hydrogen-cooled ECS 201 can further include a fuel cell 290, which is disposed in parallel with the combustor 240, and a valve 291. The fuel cell 290 can be provided as a hydrogen-based fuel cell and can be configured to generate electric power for the aircraft 101 (see FIG. 1). The valve 291 is operably disposed upstream from the combustor 240 and the fuel cell 290 and is controllable to direct a first portion of the hydrogen toward the combustor 240 and a second portion of the hydrogen toward the fuel cell 290.

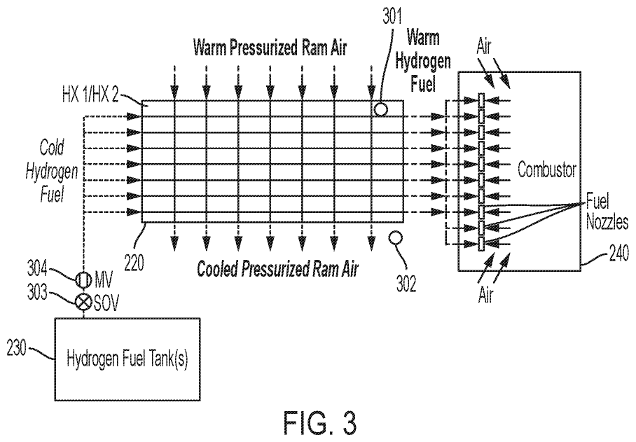

With reference to FIG. 3, the heat exchanger 220 (i.e., the first heat exchanger 2201 and the second heat exchanger 2202) is receptive of cold hydrogen fuel from the hydrogen fuel tank 230. This cold hydrogen fuel removes heat from the warm pressurized RAM air as the cold hydrogen fuel and the warm pressurized RAM air move through the heat exchanger 220. Subsequently, warm hydrogen fuel exits the heat exchanger 220 and proceeds to the combustor 240 while the cooled pressurized RAM air proceeds to the cabin 111 (see FIG. 1).

As shown in FIG. 3, the hydrogen-cooled ECS 201 can further include an internal hydrogen leak sensor 301, which is disposed within the heat exchanger 220 to detect an internal hydrogen leak thereof, an external hydrogen leak sensor 302, which is disposed at an exterior of the heat exchanger 220 to detect an external hydrogen leak, and a system of controllable valves (i.e., the valve 272 of FIG. 2, a shut-off valve 303 and a metering valve 304). The system of controllable valves can be configured to cut off a flow of the hydrogen into the heat exchanger 220 in an event of the internal hydrogen leak sensed by the internal hydrogen leak sensor 301 and to cease the flow of the hydrogen from the hydrogen fuel tank 230 in an event of the external hydrogen leak sensed by the external hydrogen leak sensor 302.

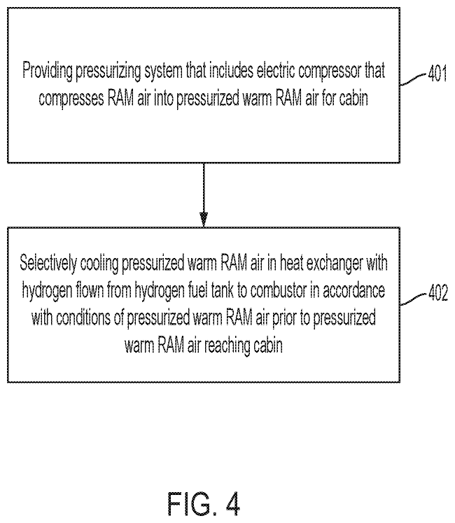

With reference to FIG. 4, a method of operating a hydrogen-cooled ECS, such as the hydrogen-cooled ECS 201 described above, is provided. The method includes providing a pressurizing system that includes an electric compressor that compresses RAM air into pressurized warm RAM air for a cabin (block 401) and selectively cooling the pressurized warm RAM air in a heat exchanger with hydrogen flown from a hydrogen fuel tank to a combustor in accordance with conditions of the pressurized warm RAM air prior to the pressurized warm RAM air reaching the cabin (block 402). As above, the cabin can be an aircraft cabin of an aircraft, the pressurizing system can be provided as first and second pressurizing systems for each side of the aircraft and the heat exchanger can be provided as first and second heat exchangers for each side of the aircraft.

The method can further include selectively using pressurized cooled RAM air from the heat exchanger for cooling an electric heat load in accordance with conditions of the pressurized cooled RAM air and the electric heat load and at least one of controllably bypassing a flow of the hydrogen around the heat exchanger, controlling an amount of the hydrogen that is permitted to flow into the combustor, cutting off a flow of the hydrogen into the heat exchanger in an event of a leak within the heat exchanger and ceasing the flow of the hydrogen in an event of a leak at an exterior of the heat exchanger.

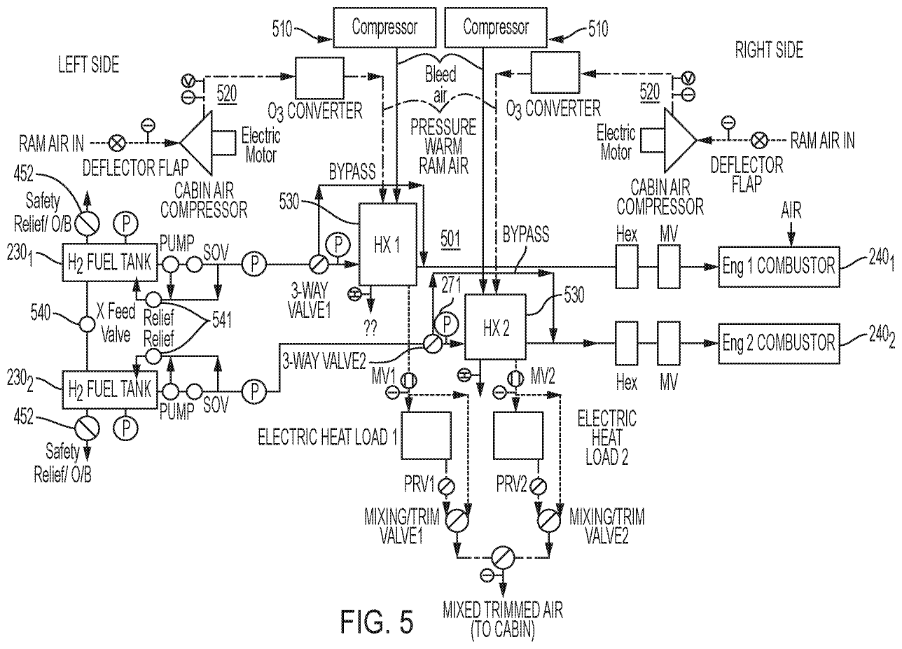

With reference to FIG. 5, a hydrogen-cooled ECS 501 is provided and is generally similar to the hydrogen-cooled ECS of FIGS. 1-3 except that the hydrogen-cooled ECS 501 includes a bleed air system 510, a pressurizing system 520 and a heat exchanger 530. The bleed air system 510 provides pressurized warm bleed air for cabin 111 from a compressor of the at least one engine 130 (see FIG. 1). The pressurizing system 520 is provided in parallel with the bleed air system 510 and is otherwise similar to the pressurizing system 210 of FIG. 2. At least one of the pressurized warm bleed air and the pressurized warm RAM air is selectively cooled within the heat exchanger 530 by hydrogen flown from the hydrogen fuel tank 230 toward the combustor 240 in accordance with respective conditions of the pressurized warm bleed air and the pressurized warm RAM air prior to the pressurized warm bleed air and the pressurized warm RAM air reaching the cabin 111 (see FIG. 1).

FIG. 5 also illustrates that the hydrogen-cooled ECS 501 can include multiple combustors (i.e., engine 1 combustor 240₁ and engine 2 combustor 240₂) and that the hydrogen fuel tank 230 can be provided as first and second hydrogen fuel tanks 230₁ and 230₂ where hydrogen fuel tank 230₁ fuels the engine 1 combustor 240₁ via a pump, a solenoid valve, a heat exchanger and a metering valve and the hydrogen fuel tank 230₂ fuels the engine 2 combustor 240₂ via a pump, a solenoid valve, a heat exchanger and a metering valve. In these or other cases, the first and second hydrogen fuel tanks 230₁ and 230₂ can be coupled via feed valve 540 and each can be provided with multiple safety/relief valves 541 and 542.

It is to be understood that the various features described above with reference to FIG. 5 can be included in at least the embodiments of FIG. 2 and vice versa. For example, the fuel cell 290 of FIG. 2 can be provided as multiple fuel cells that are respectively disposed in parallel with engine 1 combustor 240₁ and with engine 2 combustor 240₂.

Technical effects and benefits of the present disclosure are the utilization of H2 as both fuel and coolant for various on-board waste heat loads. Heated vaporized H2 fuel “keeps” (i.e., absorbs) waste heat and transfers it during combustion processes, thus improving overall thermodynamic cycle of the system. The present disclosure also provides for the use of H2 as a coolant sink for pressurized warm ram air (for ECS), utilization of avionics waste heat for warming up of pressurized cooled ram air (for ECS), the use of double-walled buffer geometry for the H2 flow inside the hydrogen-to-air heat exchangers, safety detection H2 molecule sensors for accidental H2 leak inside either heat exchanger (HX1/HX2) with a bypass for H2 around heat exchangers, a simple and lightweight and robust integrated ECS and an integrated control system that is fully integrated with on-board aircraft computers and electronic engine controllers (EECs) to fully optimize thermal management system performance.

While the disclosure is provided in detail in connection with only a limited number of embodiments, it should be readily understood that the disclosure is not limited to such disclosed embodiments. Rather, the disclosure can be modified to incorporate any number of variations, alterations, substitutions or equivalent arrangements not heretofore described, but which are commensurate with the spirit and scope of the disclosure. Additionally, while various embodiments of the disclosure have been described, it is to be understood that the exemplary embodiment(s) may include only some of the described exemplary aspects. Accordingly, the disclosure is not to be seen as limited by the foregoing description, but is only limited by the scope of the appended claims.

What is claimed is:

1. A hydrogen-cooled environmental control system (ECS), comprising:
a pressurizing system comprising an electric compressor that compresses RAM air into pressurized warm RAM air for a cabin; and
a heat exchanger in which the pressurized warm RAM air is selectively cooled by hydrogen flown from a hydrogen fuel tank toward a combustor in accordance with conditions of the pressurized warm RAM air prior to the pressurized warm RAM air reaching the cabin.

2. The hydrogen-cooled ECS according to claim 1, wherein:
the cabin is an aircraft cabin of an aircraft,
the pressurizing system is provided as first and second pressurizing systems for each side of the aircraft, and
the heat exchanger is provided as first and second heat exchangers for each side of the aircraft.

3. The hydrogen-cooled ECS according to claim 1, wherein the pressurizing system further comprises:
a RAM air inlet comprising a controllable deflector flap;
pressure and temperature sensors upstream and downstream from the electric compressor; and
an ozone converter interposed between the electric compressor and the heat exchanger.

4. The hydrogen-cooled EC according to claim 1, wherein:
the pressurizing system further comprises an electric heat load heat exchanger interposed between the heat exchanger and the cabin, and
pressurized cooled RAM air from the heat exchanger is selectively used for cooling an electric heat load in the electric heat load heat exchanger in accordance with conditions of the pressurized cooled RAM air and the electric heat load.

5. The hydrogen-cooled ECS according to claim 1, further comprising:
a bypass line by which hydrogen flown from the hydrogen fuel tank toward the combustor bypasses the heat exchanger; and
a valve which is controllable to adjust an amount of the hydrogen that is permitted to flow along the bypass line.

6. The hydrogen-cooled ECS according to claim 1, further comprising a fuel control valve upstream from the combustor to control an amount of the hydrogen that is permitted to flow into the combustor.

7. The hydrogen-cooled ECS according to claim 1, further comprising:
a fuel cell in parallel with the combustor; and
a valve which is controllable to direct a first portion of the hydrogen toward the combustor and a second portion of the hydrogen toward the fuel cell.

8. The hydrogen-cooled ECS according to claim 1, further comprising:
an internal hydrogen leak sensor disposed within the heat exchanger to detect an internal hydrogen leak thereof;
an external hydrogen leak sensor disposed at an exterior of the heat exchanger to detect an external hydrogen leak; and
a system to cut off a flow of the hydrogen into the heat exchanger in an event of the internal hydrogen leak and to cease the flow of the hydrogen in an event of the external hydrogen leak.

9. A method of operating a hydrogen-cooled environmental control system (ECS), the method comprising:
providing a pressurizing system comprising an electric compressor that compresses RAM air into pressurized warm RAM air for a cabin; and
selectively cooling the pressurized warm RAM air in a heat exchanger with hydrogen flown from a hydrogen fuel tank to a combustor in accordance with conditions of the pressurized warm RAM air prior to the pressurized warm RAM air reaching the cabin.

10. The method according to claim 9, wherein:
the cabin is an aircraft cabin of an aircraft,
the pressurizing system is provided as first and second pressurizing systems for each side of the aircraft, and
the heat exchanger is provided as first and second heat exchangers for each side of the aircraft.

11. The method according to claim 9, further comprising selectively using pressurized cooled RAM air from the heat exchanger for cooling an electric heat load in accordance with conditions of the pressurized cooled RAM air and the electric heat load.

12. The method according to claim 9, further comprising at least one of:
controllably bypassing a flow of the hydrogen around the heat exchanger;
controlling an amount of the hydrogen that is permitted to flow into the combustor;
cutting off a flow of the hydrogen into the heat exchanger in an event of a leak within the heat exchanger; and
ceasing the flow of the hydrogen in an event of a leak at an exterior of the heat exchanger.

13. A hydrogen-cooled environmental control system (ECS), comprising:
a bleed air system providing pressurized warm bleed air for a cabin;
a pressurizing system in parallel with the bleed air system and comprising an electric compressor that compresses RAM air into pressurized warm RAM air for the cabin; and
a heat exchanger in which at least one of the pressurized warm bleed air and the pressurized warm RAM air is selectively cooled by hydrogen flown from at least one hydrogen fuel tank toward at least one combustor in accordance with respective conditions of the pressurized warm bleed air and the pressurized warm RAM air prior to the pressurized warm bleed air and the pressurized warm RAM air reaching the cabin.

14. The hydrogen-cooled ECS according to claim 13, wherein:
the cabin is an aircraft cabin of an aircraft,
the bleed air system is provided as first and second bleed air systems for each side of the aircraft;
the pressurizing system is provided as first and second pressurizing systems for each side of the aircraft, and
the heat exchanger is provided as first and second heat exchangers for each side of the aircraft.

15. The hydrogen-cooled ECS according to claim 13, wherein the pressurizing system further comprises:
a RAM air inlet comprising a controllable deflector flap;
pressure and temperature sensors upstream and downstream from the electric compressor; and
an ozone converter interposed between the electric compressor and the heat exchanger.

16. The hydrogen-cooled ECS according to claim 13, wherein:
the pressurizing system further comprises an electric heat load heat exchanger interposed between the heat exchanger and the cabin, and
pressurized cooled RAM air from the heat exchanger is selectively used for cooling an electric heat load in the electric heat load heat exchanger in accordance with conditions of the pressurized cooled RAM air and the electric heat load.

17. The hydrogen-cooled ECS according to claim 13, further comprising:
a bypass line by which hydrogen flown from the at least one hydrogen fuel tank toward the at least one combustor bypasses the heat exchanger; and
a valve which is controllable to adjust an amount of the hydrogen that is permitted to flow along the bypass line.

18. The hydrogen-cooled ECS according to claim 13, further comprising a fuel control valve upstream from the at least one combustor to control an amount of the hydrogen that is permitted to flow into the at least one combustor.

19. The hydrogen-cooled ECS according to claim 13, further comprising:
a fuel cell in parallel with the at least one combustor; and
a valve which is controllable to direct a first portion of the hydrogen toward the at least one combustor and a second portion of the hydrogen toward the fuel cell.

20. The hydrogen-cooled ECS according to claim 13, further comprising:
an internal hydrogen leak sensor disposed within the heat exchanger to detect an internal hydrogen leak thereof;
an external hydrogen leak sensor disposed at an exterior of the heat exchanger to detect an external hydrogen leak; and
a system to cut off a flow of the hydrogen into the heat exchanger in an event of the internal hydrogen leak and to cease the flow of the hydrogen in an event of the external hydrogen leak.
